(19) United States
(12) Patent Application Publication
(10) Pub. No.: US 2023/0069066 A1
(43) Pub. Date: Mar. 2, 2023

(54) MOTOR CONTROL DEVICE AND METHOD

(71) Applicant: MANDO CORPORATION, Gyeonggi-do (KR)

(72) Inventor: Jae Hoon BAE, Gyeonggi-do (KR)

(21) Appl. No.: 17/886,464

(22) Filed: Aug. 12, 2022

(30) Foreign Application Priority Data
Aug. 13, 2021 (KR) 10-2021-0107104

(51) Int. Cl. B62D 5/04; B62D 15/02

(52) U.S. Cl. CPC B62D 5/0463; B62D 5/0481; B62D 15/021

(57) ABSTRACT

The disclosure relates to a motor control device and method and comprises a calculator calculating friction control information for controlling friction of a steering device based on vehicle state information including information regarding a state of a vehicle and preset system friction information and a controller performing either friction decrease control to control to reduce the friction of the steering device or friction increase control to control to increase the friction of the steering device, based on the friction control information.

### CROSS-REFERENCE TO RELATED APPLICATION

This application claims priority from Korean Patent Application No. 10-2021-0107104, filed on Aug. 13, 2021, which is hereby incorporated by reference for all purposes as if fully set forth herein.

### BACKGROUND

### Field

The disclosure relates to a motor control device and method and, more specifically, to a device and method for controlling a motor so that friction may be adjusted in a vehicle steering device.

### Description of Related Art

In the vehicle steering device, friction causes a frictional force that acts in the direction opposite to the direction of the external force applied to the steering wheel, affecting the driver's steering to feel resistance. The degree of resistance transferred to the steering wheel due to friction may be somewhat adjusted by the torque generated from the steering motor.

However, the torque generated by the steering motor is limited by the motor specifications, such as motor size and maximum output. Accordingly, to increase the friction of the steering device to a sufficient level, the motor size needs to be increased.

### BRIEF SUMMARY

The disclosure provides a motor control device and method capable of controlling the magnitude of friction of the steering device depending on the condition of the vehicle.

The disclosure provides a motor control device and method capable of reducing the torque required for the motor in controlling the friction of the steering device and optimizing the motor size.

The disclosure also provides a motor control device and method capable of more sophisticated friction control by monitoring the friction of the steering device.

In an aspect, the present embodiments may provide a motor control device comprising a calculator calculating friction control information for controlling friction of a steering device based on vehicle state information including information regarding a state of a vehicle and preset system friction information and a controller performing either friction decrease control to control to reduce the friction of the steering device or friction increase control to control to increase the friction of the steering device, based on the friction control information, wherein the vehicle state information includes steering torque information about the vehicle.

In another aspect, the present embodiments may provide a motor control method comprising a friction calculation step calculating friction control information for controlling friction of a steering device based on vehicle state information including information regarding a state of a vehicle and preset system friction information and a friction control step performing either friction decrease control to control to reduce the friction of the steering device or friction increase control to control to increase the friction of the steering device, based on the friction control information, wherein the vehicle state information includes steering torque information about the vehicle.

The disclosure may provide a motor control device and method capable of controlling the magnitude of friction of the steering device depending on the condition of the vehicle.

The disclosure may provide a motor control device and method capable of reducing the torque required for the motor in controlling the friction of the steering device and optimizing the motor size.

The disclosure may also provide a motor control device and method capable of more sophisticated friction control by monitoring the friction of the steering device.

### DESCRIPTION OF DRAWINGS

The above and other objects, features, and advantages of the disclosure will be more clearly understood from the following detailed description, taken in conjunction with the accompanying drawings, in which:

FIG. 1 is a block diagram illustrating a motor control device according to the disclosure;

FIG. 2 is a view illustrating an example configuration of a steering device including a motor control device according to an embodiment;

FIG. 3 is a graph illustrating an example of friction tuning of a steering device mechanism according to an embodiment;

FIGS. 4, 5, and 6 are graphs illustrating an example of friction control of a steering device according to an embodiment;

FIG. 7 is a view illustrating an example of performing friction decrease control according to an embodiment;

FIG. 8 is a view illustrating an example of performing friction increase control according to an embodiment;

FIG. 9 is a flowchart illustrating a motor control method according to an embodiment; and

FIG. 10 is a flowchart illustrating an example configuration for friction monitoring and correction according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the condition clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

In the disclosure, friction is defined as meaning friction that occurs when a device operates. To describe friction related to rotation in the steering device, e.g., rotation of the steering wheel, steering column, and steering motor, friction as used herein is defined as represented as torque (unit: Nm).

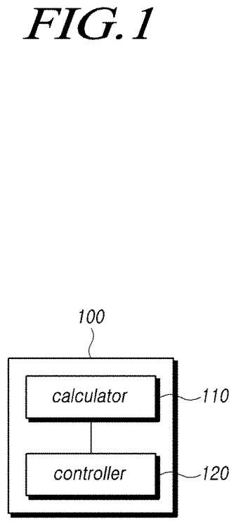

FIG. 1 is a block diagram illustrating a motor control device according to the disclosure.

Referring to FIG. 1, a motor control device 100 according to the disclosure may include a calculator 110 and a controller 120. The calculator 110 and the controller 120 may be connected to each other.

As an example, a motor control device 100 may comprise a calculator 110 calculating friction control information for controlling to adjust friction of a steering device based on vehicle state information including information regarding a state of a vehicle and preset system friction information and a controller 120 performing either friction decrease control to control to reduce the friction of the steering device or friction increase control to control to increase the friction of the steering device, based on the friction control information.

The calculator 110 may calculate friction control information based on vehicle state information and system friction information.

The vehicle state information may include at least one or more pieces of information about the state of the vehicle. The vehicle state information may include any information that may be sensed or measured in relation to the state of the driven vehicle.

As an example, the vehicle state information may include at least one of steering torque information, vehicle velocity information, steering angle information, or gear shift state information about the vehicle.

The steering torque information may include information about the steering torque applied to the steering column by an external force applied to the steering wheel. The friction of the steering device may act in the opposite direction to the steering torque.

The vehicle velocity information may include information about the velocity of the vehicle. In this case, the vehicle velocity information may be generated based on the signal sensed by a vehicle velocity sensor. Alternatively, the vehicle velocity information may include any information regarding the vehicle velocity, generated based on a component capable of vehicle velocity measurement, such as a wheel position sensor, radar, or lidar, other than the sensing signal from the vehicle velocity sensor.

The steering angle information may include information about the steering angle of the steering wheel. The steering angle may include at least one of a relative steering angle or an absolute steering angle. The steering angle information may be generated based on the signal sensed by the steering angle sensor. Alternatively, the steering angle information may include any steering angle-related information generated based on a component capable of steering angle measurement, such as a motor position sensor or a torque sensor, other than the steering angle sensor.

The gear shift state information may include information about the gear shift state of the vehicle. The gear shift state may include any information regarding the gear shift state of a manual shift vehicle and an automatic shift vehicle.

For example, for the manual shift vehicle, the gear shift state information may include information about the neutral state, reverse state, and state corresponding to each gear stage and, for the automatic shift vehicle, the gear shift state information may include information about the parking state, reverse state, neutral state, drive state, and state corresponding to each gear stage.

The system friction information may include information regarding the system friction of the steering device. As an example, system friction may be defined as friction fundamentally generated from the steering device mechanism, regardless of the state of the vehicle.

In this case, the system friction information may be in the form of a preset value as stored. Alternatively, the system friction information may be generated based on a result of measuring the friction of the steering device by a predetermined method in the vehicle.

For example, information calculated based on a result of measuring the friction of the steering device mechanism by applying current for measuring friction to the steering motor while there is no movement of the steering wheel, and the vehicle is not driven may be generated as the system friction information.

The system friction information may be corrected. For example, the system friction information may be corrected based on the information calculated based on the above-described friction measurement result.

In this case, correction of the system friction information may be controlled to be performed when a preset condition is met. For example, the existing system friction information may be compared with the friction measurement result to calculate a friction difference value and, when the friction difference value is a preset correction reference value or more, the system friction information may be corrected.

The system friction may affect the calculation of the magnitude of the motor torque to be generated to the steering motor. Further, typically since the maximum output of a motor is related to the size of the motor, the motor specifications and motor size required may be varied depending on the range of the motor torque to be generated in the steering motor.

For example, if the friction torque required for the steering device for each vehicle state ranges from 0 Nm to 30 Nm, and the system friction is 0 Nm, the steering motor is required to a motor torque in the range from 0 Nm to 30 Nm, so that the required motor should be able to generate a torque up to 30 Nm.

As another example, if the friction torque ranges from 0 Nm to 30 Nm, and the system friction is 15 Nm, the motor torque may be generated in the range from −15 Nm to +15 Nm, so that the needed motor should be able to generate a torque up to 15 Nm.

In other words, the maximum torque required for the steering motor is varied depending on the magnitude of the system friction of the steering device, so that the size of the steering motor is also varied depending on the maximum torque output.

The calculator 110 may calculate friction torque information based on the vehicle state information and preset table information. The friction torque information may include information regarding the friction torque required for the steering device for each vehicle state.

The table information may include information stored in the form of a table of the friction torque required for the steering device for each vehicle state. For example, the table information may include table-type information regarding the friction torque required for the steering device for each vehicle state, such as the ingress state, egress state, lock stop state, and driving state. In this case, the driving state may be divided into a slow driving state and a fast driving state based on a preset high/low reference vehicle velocity.

In some cases, the table information may be identified as the driving state without differentiating between the slow driving state and the fast driving state. In this case, the friction torque information described below may be calculated based on vehicle velocity information and a preset formula, rather than as a fixed value determined according to the table information.

As an example, the calculator 110 may calculate the friction torque information based on the vehicle velocity information and the table information.

For example, when the vehicle velocity information is determined to be less than a preset stop reference velocity, the vehicle may be determined to be in the ingress state or egress state, and the friction torque required in the ingress state or egress state based on the table information may be calculated as the friction torque information.

As another example, when the vehicle velocity information is determined to be the stop reference velocity or more, the vehicle may be determined to be driving, and the friction torque required in the driving state based on the table information may be calculated as the friction torque information.

In some cases, when the vehicle is determined to be in the driving state based on the vehicle state information, the friction torque information may be calculated based on a formula preset based on the vehicle velocity information.

As another example, the calculator 110 may calculate the friction torque information based on the steering angle information and the table information.

For example, when the steering angle information is determined to be a preset limit steering angle or more, the vehicle may be determined to be in the lock stop state, and the friction torque required in the lock stop state based on the table information may be calculated as the friction torque information.

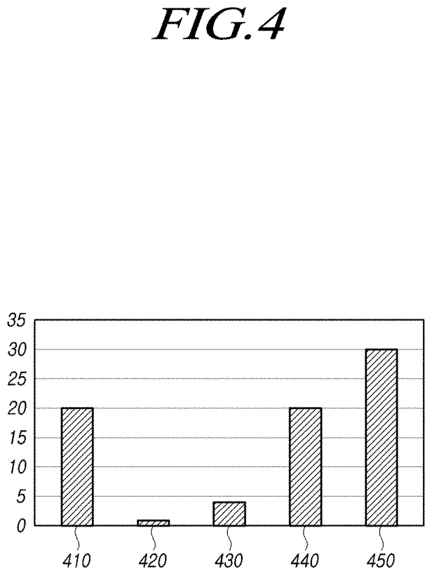

The calculation of friction torque information is described below in greater detail with reference to FIGS. 4 to 6.

The calculator 110 may calculate friction control information based on vehicle state information and system friction information. As described above, the friction torque information may be calculated based on the vehicle state information and the table information, and then, the friction control information may be calculated based on the friction torque information and the system friction information.

For example, the friction torque information may be calculated by finding the required friction torque corresponding to the vehicle state from the table information based on the vehicle state information. The magnitude of the torque to be generated to the steering motor may be calculated by comparing the friction torque information and the system friction information, and it may be determined which one of the friction decrease control or friction increase control is to be performed.

Then, the direction in which the friction control is actually performed may be determined based on the steering torque information, calculating the friction control information.

For example, it may be determined to perform the friction decrease control and that the steering torque information is clockwise. In this case, the friction control information may be calculated in such a manner that the steering motor is controlled to generate a friction torque clockwise which is the same direction as the steering torque information to be able to reduce the friction of the steering device or that a smaller friction torque than the existing friction torque is controlled to be generated to the steering motor.

In contrast, it may be determined to perform the friction increase control and that the steering torque information is counterclockwise. In this case, the friction control information may be calculated in such a manner that the steering motor is controlled to generate a friction torque counterclockwise which is the opposite direction to the steering torque information to be able to increase the friction of the steering device or that a larger friction torque than the existing friction torque is controlled to be generated to the steering motor.

The calculator 110 may compare the result of friction measurement control by the controller 120 with the system friction information to calculate the friction difference value as described below. When the friction difference value is a preset correction reference value or more, the system friction information may be corrected based on the friction measurement control result.

The controller 120 may perform either the friction decrease control or the friction increase control based on the friction control information. Specifically, the friction control information may include information for controlling to generate a motor torque of a specific magnitude in a specific direction.

The magnitude and direction of the motor torque may be determined based on the friction torque information, system friction information, and steering torque information as described with reference to the calculator 110.

For example, the magnitude of the motor torque may be represented as the following equation.

Motor torque=friction torque−system friction [Equation 1]

If the magnitude of the motor torque is negative, the steering motor may be controlled to generate a motor torque in the same direction as the direction of the steering torque to allow the magnitude of the friction generated in the steering device to be smaller than the system friction. Conversely, if the magnitude of the motor torque is positive, the steering motor may be controlled to generate a motor torque in the opposite direction to the direction of the steering torque.

The controller 120 may perform friction measurement control based on the friction measurement control information for controlling to measure the friction of the steering device. The friction measurement control information may be information included in the friction control information.

Since the friction measurement result may be used in comparison with the system friction of the steering device and correction, it needs to be measured in the state in which the vehicle and the steering wheel are stopped so that other friction than the system friction is not measured. Accordingly, the friction measurement control may be set to be performed when a preset friction measurement condition is met.

For example, the friction measurement condition may be set to include at least one of a condition where the gear shift state information about the vehicle is determined to be a parking state or a neutral state, a condition where the vehicle velocity information is determined to be less than a preset stop reference velocity, or a condition where the steering torque information is determined to be less than a preset stop reference torque.

The friction measurement control may be performed in such a manner as to perform measurement by applying a friction measurement current for measuring the friction of the steering device to the steering motor. In this case, the friction measurement current may be allowed to be applied to the steering motor when the above-described friction measurement condition is met, so that the accuracy of friction measurement is increased.

When the friction measurement control is performed so that the friction of the steering device is measured, the calculator 110 may compare the friction measurement result with the system friction information to calculate the friction difference value.

As a result of the calculation, if the friction difference value is less than a preset correction reference value, this may mean that there is no significant change between the friction measurement result and the existing system friction information, so that the friction decrease control or friction increase control may be performed without correcting the system friction information.

If the friction difference value is the correction reference value or more, correction may be performed to apply the friction measurement result to the system friction information, and friction decrease control or friction increase control may be performed based on the corrected system friction information.

As described above, friction measurement control and system friction information correction may reflect changes in the system friction of the steering device due to, e.g., component wear or weather changes, and thus allow for more accurate friction control.

In cases where the vehicle includes a steer-by-wire steering device, i.e., when the steering wheel and the steering column are physically separated from the rack device and wheels, and steering is performed via electronic linking, the friction control and friction decrease/increase control described herein may play a more significant role in increasing steering stability and preventing accidents.

For example, the lock stop or loss of assist (LOA) condition requires that the friction of the steering device be increased. In driving the steering device, high stability may be achieved by increasing the system friction and performing friction increase control as described herein.

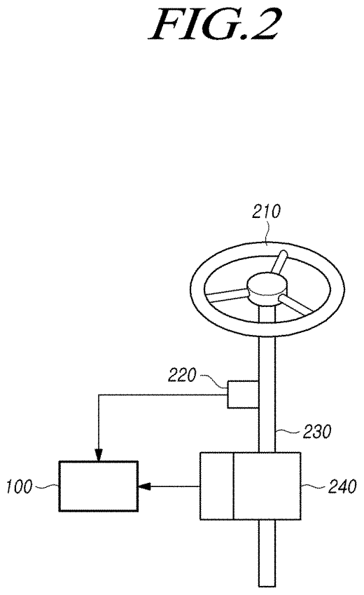

FIG. 2 is a view illustrating an example configuration of a steering device including a motor control device according to an embodiment.

Referring to FIG. 2, the steering device may include at least one of a motor control device 100, a steering wheel 210, a steering torque sensor 220, a steering column 230, or a steering motor 240.

As an example, the motor control device 100 may calculate the friction torque information based on the vehicle state information and the table information. The motor control device 100 may calculate the friction torque information and information regarding the magnitude of the motor torque to be generated to the steering motor based on the friction torque information and system friction information.

The motor control device 100 may receive steering torque information regarding the steering torque applied to at least one of the steering wheel 210 or the steering column 230, from the steering torque sensor 220. The motor control device 100 may calculate information regarding the direction of the motor torque to be generated to the steering motor based on the steering torque information and friction torque information.

In other words, the motor control device 100 may calculate the friction control information including information regarding the direction and magnitude of the motor torque to be generated to the steering motor to perform friction control based on the vehicle state information, table information, and system friction information.

Then, the motor control device 100 may perform either friction decrease control to control to generate a motor torque in the same direction as the steering torque information or friction increase control to control to generate a motor torque in the opposite direction to the steering torque information, based on the friction control information.

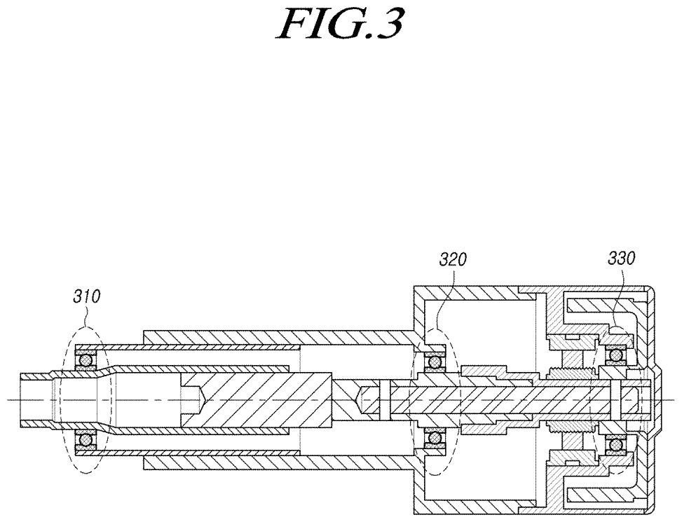

FIG. 3 is a graph illustrating an example of friction tuning of a steering device mechanism according to an embodiment.

In general, the friction of a mechanism may be determined to differ depending on the structure in which each component is connected. Thus, friction tuning may be performed in such a manner as to make a change to the connection structure.

Likewise, for the system friction in the steering device mechanism, friction tuning may be carried out in a way to make a change to each connection structure in the steering device mechanism.

Referring to FIG. 3, the steering device according to an embodiment may include a mechanism having at least one or more components connected to each other and, when the steering device operates, friction may occur. The steering device mechanism may include at least one or more bearings for adjusting the friction between parts.

As an example, the steering device mechanism shown in FIG. 3 may include at least one of a first bearing 310, a second bearing 320, or a third bearing 330. The friction tuning of the steering device mechanism may be performed using the stiffness and damping coefficient characteristics of each bearing.

For example, for each of the first bearing 310, the second bearing 320, and the third bearing 330, one of several bearings having different stiffness and damping coefficients is installed and, after installation, the friction of the steering device mechanism is measured and, based on the measurement result, at least one of the first bearing 310, the second bearing 320, and the third bearing 330 is replaced with another bearing, and friction measurement is repeated. In such a manner, friction tuning may be performed.

As another example, at least one of the firs bearing 310, the second bearing 320, or the third bearing 330 may be formed of a pressure bearing. In this case, since the pressure bearing has a characteristic that may adjust its stiffness and damping coefficient, tuning may be performed using such characteristic so that the friction of the steering device mechanism has a specific value, even without replacing the bearing.

If the system friction of the steering device mechanism is tuned in such a manner, it is possible to set the system friction to an adequate magnitude considering the friction torque range required for the steering device for each vehicle state. The system friction may affect the calculation of the magnitude of the motor torque to be generated to the steering motor.

Typically since the maximum output of a motor is related to the size of the motor, the motor specifications and motor size required may be varied depending on the range of the motor torque to be generated in the steering motor.

For example, in a case where the friction torque ranges from 0 Nm to 30 Nm, if system friction is 0 Nm, a motor having a maximum output of 30 Nm which may generate a motor torque in the range from 0 Nm to +30 Nm is needed as the steering motor but, if the system friction is 15 Nm, a motor having a maximum output of 15Nm which may generate a motor torque in the range from −15 Nm to +15Nm is required.

In other words, the maximum torque required for the steering motor is varied depending on the magnitude of the system friction of the steering device, so that the size of the steering motor is also varied depending on the maximum torque output.

As such, if the system friction tuning for the steering device is properly performed, and friction control for the steering motor according to the disclosure is performed based on the tuned system friction, it is possible to increase the efficiency of friction control while optimizing the size of the steering motor. This leads to cost savings and allows the steering device more competitive.

FIGS. 4, 5, and 6 are graphs illustrating an example of friction control of a steering device according to an embodiment.

Referring to FIG. 4, the friction control of the steering device according to an embodiment may be performed based on at least one state of an ingress state 410, a slow driving state 420, a fast driving state 430, an egress state 440, or a lock stop state 450.

Specifically, FIG. 4 is a graph showing information regarding the ingress state 410, slow driving state 420, fast driving state 430, egress state 440, and lock stop state 450 in relation to the friction of the steering device. Table 1 below shows the in the form of a table.

A configuration of controlling the friction of the steering device using the steering motor is described below with reference to FIGS. 4 to 6 and Tables 1 to 3.

TABLE 1

| Vehicle state | Torque (unit: Nm) |
|---|---|
| Ingress | 20 |
| Slow Driving | 1 |
| Fast Driving | 4 |
| Egress | 20 |
| Lock Stop | 30 |

Table 1 exemplarily shows the friction torque information required for the steering device for each vehicle state. As shown in Table 1, the friction of the steering device may be represented in the form of torque. In other words, the force corresponding to the torque shown for each state may be set to act as a frictional force.

As an example, when the vehicle is in the ingress state 410 or egress state 440, the friction torque information may be set to 20 Nm. When the steering wheel is in the lock stop state 450 the friction torque information may be set to 30 Nm.

The lock stop state 450 may include a state in which the steering wheel should be prohibited from rotating in a specific direction, such as the steering wheel rotating by a preset limit steering angle or more.

Since in the ingress state 410, egress state 440, and lock stop state 450, frictional force needs to act with the steering wheel stopped, the frictional force in this case may be set to act as a static frictional force.

As another example, in the slow driving state 420 of the vehicle, the friction torque information may be set to 1 Nm and, in the fast driving state 430, the friction torque information may be set to 4 Nm.

In the slow driving state 420 and fast driving state 430, frictional force needs to act while the steering wheel is rotated, so that the frictional force in this case may be set to act as a kinetic frictional force.

The friction of the steering device may be represented based on the motor torque generated in the steering motor and the system friction of the steering device. This may be exemplified by way of the equation as follows.

Friction of steering device=system friction+motor torque [Equation 2]

The above equation may be summarized into a motor torque-related equation as follows.

Motor torque=friction of steering device −system friction

In other words, the friction of the steering device may be controlled by controlling the generation of motor torque. For example, to generate a smaller magnitude of steering device friction than the system friction, the motor torque may be controlled to be generated in the same direction as the steering torque and, to generate a larger magnitude of steering device friction than the system friction, the motor torque may be controlled to be generated in the opposite direction of the steering torque.

Based thereupon, control may be performed to meet the friction torque required for each vehicle state as exemplified in Table 1.

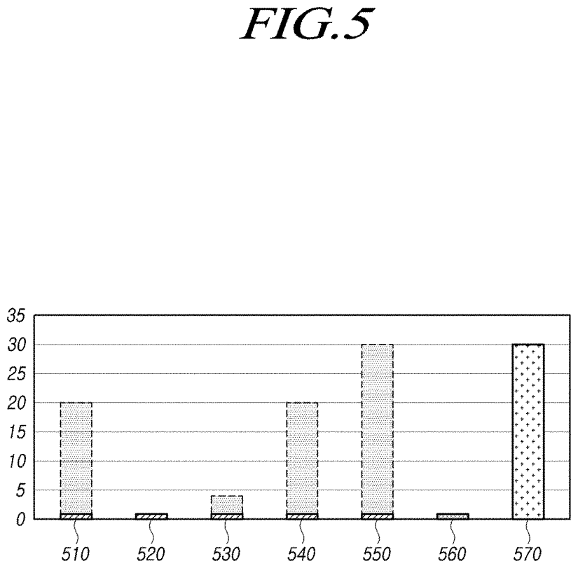

Referring to FIG. 5, when the system friction is tuned to be relatively low, the steering device according to an embodiment may perform friction control by generate a motor torque according to each vehicle state based on the system friction.

Specifically, FIG. 5 is a graph showing information regarding the ingress state 510, slow driving state 520, fast driving state 530, egress state 540, lock stop state 550, system friction 560, and motor torque output 570 in relation to the friction of the steering device. Table 2 below shows the in the form of a table.

TABLE 2

| Vehicle state | Torque (unit: Nm) |
|---|---|
| Ingress | 20 |
| Slow Driving | 1 |
| Fast Driving | 4 |
| Egress | 20 |
| Lock Stop | 30 |
| System Friction | 1 |
| Reduced Motor Torque | 30 |

Table 2 shows an example in which the system friction 560 is tuned to be relatively low as 1 Nm, along with the friction torque information for each vehicle state. In this case, referring to Equation 2, the motor torque may be calculated by subtracting 1 Nm from the friction of the steering device.

Referring to FIG. 5 and Table 2, the friction torque information is 1 Nm or more in all of the given vehicle states, so that such an occasion does not occur where the motor torque is calculated as negative. In other words, for each vehicle state, only friction increase control is performed.

For example, the motor torque is calculated as 20 Nm−1 Nm=+19 Nm in the vehicle ingress state 510 or egress state 540, as 30 Nm−1 Nm=+29 Nm in the lock stop state 550, and as 4 Nm−1 Nm=+3 Nm in the fast driving state 530, and friction increase control for generating a motor torque having each corresponding magnitude is performed so that friction control may be performed to meet the friction torque information for each vehicle state.

Since in the slow driving state 520 of the vehicle, the motor torque is calculated as 1 Nm−1 Nm=0 Nm, the vehicle may be driven in the state of meeting the friction torque information although friction control is not separately performed.

As such, to perform friction control when the system friction is 1 Nm, the steering device needs to be configured of a motor having a maximum output of 29 Nm or more considering 29 Nm which is the motor torque in the lock stop state 550. Table 2 above shows an example in which the steering device is configured of a motor having a motor torque output 570 of 30 Nm in such a circumstance.

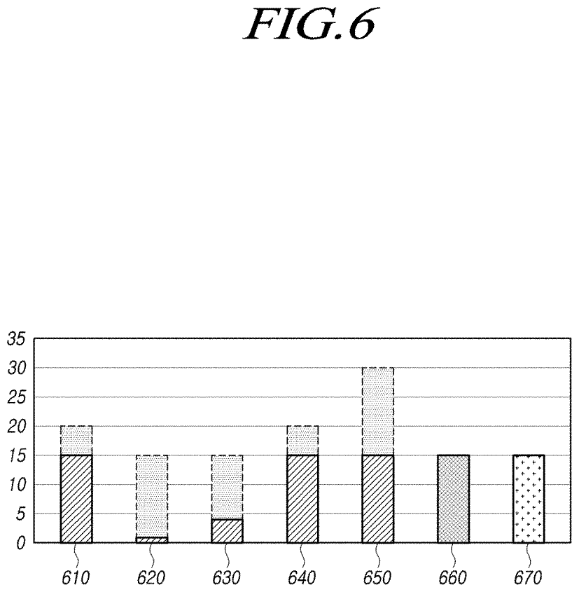

Referring to FIG. 6, when the system friction is tuned to be relatively high, the steering device according to an embodiment may perform friction control by generate a motor torque according to each vehicle state based on the system friction tuned to be high.

Specifically, FIG. 6 is a graph showing information regarding the ingress state 610, slow driving state 620, fast driving state 630, egress state 640, lock stop state 650, system friction 660, and motor torque output 670 in relation to the friction of the steering device. Table 3 below shows the in the form of a table.

TABLE 3

| Vehicle state | Torque (unit: Nm) |
|---|---|
| Ingress | 20 |
| Slow Driving | 1 |
| Fast Driving | 4 |
| Egress | 20 |
| Lock Stop | 30 |
| System Friction | 15 |
| Reduced Motor Torque | 15 |

Table 3 shows an example in which the system friction is tuned to be relatively high as 15 Nm, along with the friction torque information for each vehicle state. In this case, referring to Equation 2, the motor torque may be calculated by subtracting 15 Nm from the friction of the steering device.

Referring to FIG. 6 and Table 3, the friction torque information may be calculated as negative in some cases or as positive in other cases, for each given vehicle state. In other words, in this case, either friction decrease control or friction increase control is performed depending on each vehicle state.

For example, the motor torque is calculated as 20 Nm−15 Nm=+5 Nm, i.e., a positive number, in the vehicle ingress state 610 or egress state 640, and as 30 Nm−15 Nm=+15 Nm, i.e., a positive number, in the lock stop state 650, and friction increase control for generating a motor torque having each corresponding magnitude is performed so that friction control may be performed to meet the friction torque information for each vehicle state.

For example, the motor torque is calculated as 1 Nm−15 Nm=−14 Nm, i.e., a negative number, in the slow driving state 620 of the vehicle, and as 4 Nm−15 Nm=−11 Nm, i.e., a negative number, in the fast driving state 630, and friction decrease control for generating a motor torque having each corresponding magnitude is performed so that friction control may be performed to meet the friction torque information for each vehicle state.

To perform friction control in such a case, the steering motor needs to be configured of a motor having a maximum output of 15 Nm or more given that the motor torque in the lock stop state 650 is +15 Nm and the motor torque in the slow driving state 620 is −14 Nm. Table 2 above shows an example in which the steering device is configured of a motor having a motor torque output 670 of 15 Nm in such a circumstance.

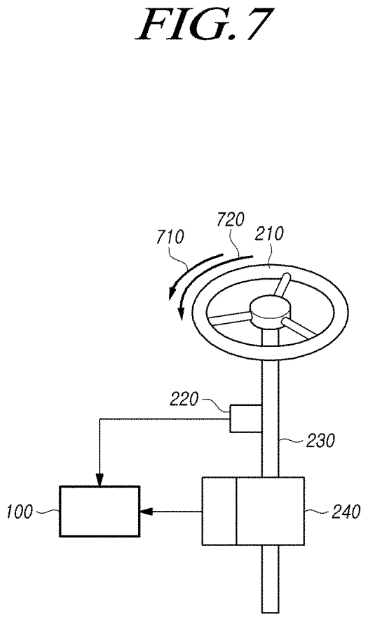

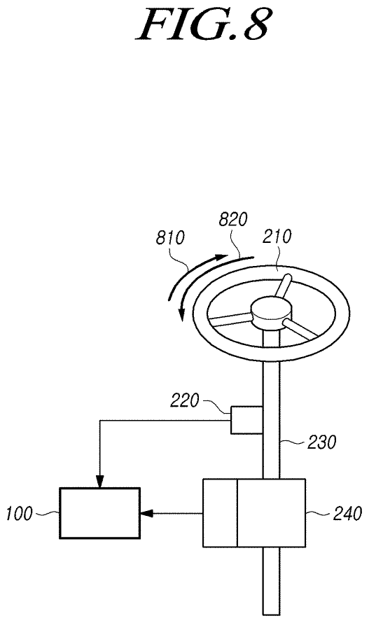

A configuration of performing friction decrease control and friction increase control using the steering motor is described below with reference to FIGS. 7 and 8.

It is assumed here that for the steering device, table information regarding the friction torque information for each vehicle is set according to Table 3, the system friction of the steering device is tuned to be relatively high as 15 Nm, and the steering motor is configured of a motor having a maximum output of 15 Nm.

FIG. 7 is a view illustrating an example of performing friction decrease control according to an embodiment.

Referring to FIG. 7, the motor control device 100 according to an embodiment may calculate friction control information and perform friction decrease control based on the friction control information.

In this case, the motor control device 100 may control to generate a motor torque 710 in the same direction as the steering torque 720 to thereby perform friction decrease control.

As an example, if the stop reference velocity is set to 1 Km/h, high/low reference velocity is set to 60 Km/h, and vehicle velocity information is determined to be 50 Km/h, the motor control device 100 may determine that the vehicle is in the slow driving state and calculate the friction torque information as 1 Nm based on the table information of Table 3 and the vehicle state information.

Since the system friction information is set to 15 Nm, the motor torque 710 may be calculated as 1 Nm−15 Nm=−14 Nm. In other words, friction control information to generate a motor torque 710 having a magnitude of 14 Nm and the same direction as the steering torque 720 may be calculated.

In this case, if external force is applied to the steering wheel counterclockwise, the motor control device 100 may receive steering torque information from the steering torque sensor 220 and perform friction increase control to generate a motor torque 710 having a magnitude of 14 Nm and the counterclockwise direction which is the same direction as the steering torque 720 to the steering motor.

Accordingly, since the friction of the steering device which is system friction 15 Nm−motor torque 14 Nm=1 Nm is generated, friction control meeting the friction torque information 1 Nm is performed.

As another example, if the stop reference velocity is set to 1 Km/h, high/low reference velocity is set to 60 Km/h, and vehicle velocity information is determined to be 100 Km/h, the motor control device 100 may determine that the vehicle is in the fast driving state and calculate the friction torque information as 4 Nm based on the table information of Table 3 and the vehicle state information.

Since the system friction information is set to 15 Nm, the motor torque 710 may be calculated as 4 Nm−15 Nm=−11 Nm. In other words, friction control information to generate a motor torque 710 having a magnitude of 11 Nm and the same direction as the steering torque 720 may be calculated.

In this case, if external force is applied to the steering wheel counterclockwise, the motor control device 100 may receive steering torque information from the steering torque sensor 220 and perform friction increase control to generate a motor torque 710 having a magnitude of 11 Nm and the counterclockwise direction which is the same direction as the steering torque 720 to the steering motor.

Accordingly, since the friction of the steering device which is system friction 15 Nm−motor torque 11 Nm=4 Nm is generated, friction control meeting the friction torque information 4 Nm is performed.

As another example, the motor control device 100 may set the table information without differentiating between slow driving state and fast driving state. When the vehicle state is the driving state, the friction torque information may be calculated based on vehicle velocity information and a preset equation, rather than a fixed value determined according to the table information.

For example, the friction torque information may be calculated to increase/decrease by 1 Nm every 20 Km/h with respect to 3 Nm at 60 Km/h. This may be exemplified by way of the equation as follows.

Friction torque information in driving state=3+(vehicle velocity−60)×0.05 (Nm)

According to the equation, when the vehicle velocity is 40 Km/h, the friction torque information may be calculated as 3+(40−60)×0.05=2 Nm and, when the vehicle velocity is 100 Km/h, the friction torque information may be calculated as 3+(100−60)×0.05=5 Nm.

Since the system friction information is set to 15 Nm, the motor torque 710 may be calculated as 2 Nm−15 Nm=−13 Nm when the vehicle velocity is 40 Km/h and, when the vehicle velocity is 100 Km/h, the motor torque 710 may be calculated as 5 Nm-15 Nm=−10 Nm.

In other words, when the vehicle velocity is 40 Km/h, friction control information to generate a motor torque 710 having a magnitude of 13 Nm and the same direction as the steering torque 720 may be calculated and, when the vehicle velocity is 100 Km/h, friction control information to generate a motor torque 710 having a magnitude of 10 Nm and having the same direction as the steering torque 720 may be calculated.

In this case, if clockwise external force is applied to the steering wheel, the motor control device 100 may receive steering torque information from the steering torque sensor 220. Accordingly, when the vehicle velocity is 40 Km/h, friction increase control to generate a motor torque 710 having a magnitude of 13 Nm and the counterclockwise direction which is the same direction as steering torque information to the steering motor may be performed and, when the vehicle velocity is 100 Km/h, friction increase control to generate a motor torque 710 having a magnitude of 10 Nm and having the counterclockwise direction which is the same direction as the steering torque information to the steering motor may be performed.

Accordingly, when the vehicle velocity is 40 Km/h, the friction of the steering device of system friction 15 Nm−motor torque 13 Nm=2 Nm is generated, friction control meeting the friction torque information of 2 Nm is performed and, when the vehicle velocity is 100 Km/h, the friction of system friction 15 Nm−motor torque 10 Nm=5 Nm is generated, friction control meeting the friction torque information of 5 Nm is performed.

FIG. 8 is a view illustrating an example of performing friction increase control according to an embodiment.

Referring to FIG. 8, the motor control device 100 according to an embodiment may calculate friction control information and perform friction increase control based on the friction control information.

As an example, when the stop reference velocity is set to 1 Km/h, and the vehicle velocity information is determined to be 0 Km/h, the motor control device 100 may determine that the vehicle is in the stopped state based on the vehicle state information.

Accordingly, the motor control device 100 may determine that the vehicle is in the ingress state or egress state and calculate the friction torque information as 20 Nm based on the vehicle state information and the table information of Table 3.

Since the system friction information is set to 15 Nm, the motor torque 810 may be calculated as 20 Nm−15 Nm=+5 Nm. In other words, friction control information to generate a motor torque 810 having a magnitude of 5 Nm and the opposite direction to the steering torque 820 may be calculated.

In this case, if external force is applied to the steering wheel counterclockwise, the motor control device 100 may receive steering torque information from the steering torque sensor 220 and perform friction increase control to generate a motor torque 810 having a magnitude of 5 Nm and the clockwise direction which is the opposite direction to the steering torque 820 to the steering motor.

Accordingly, since the friction of the steering device which is system friction 15 Nm+motor torque 5 Nm=20 Nm is generated, friction control meeting the friction torque information 20 Nm is performed.

As another example, if the limit steering angle is set to 170°, and the steering angle information is determined to be 170°, the motor control device 100 may determine that the vehicle is in the lock stop state and calculate the friction torque information as 30 Nm based on the table information of Table 3 and the vehicle state information.

Since the system friction information is set to 15 Nm, the motor torque 810 may be calculated as 30 Nm−15 Nm=+15 Nm. In other words, friction control information to generate a motor torque 810 having a magnitude of 15 Nm and the opposite direction to the steering torque information may be calculated.

In this case, if external force is applied to the steering wheel counterclockwise, the motor control device 100 may receive steering torque information from the steering torque sensor 220 and perform friction increase control to generate a motor torque 810 having a magnitude of 15 Nm and the clockwise direction which is the opposite direction to the steering torque 820 to the steering motor.

Accordingly, since the friction of the steering device which is system friction 15 Nm+motor torque 15 Nm=30 Nm is generated, friction control meeting the friction torque information 30 Nm is performed.

As described above, the motor control device 100 according to the disclosure may tune the system friction of the steering device mechanism and perform either friction decrease control or friction increase control according to the friction required according to the vehicle state.

The motor control device 100 may reduce the control range of friction increase control through friction tuning and friction control. Accordingly, the motor control device 100 may reduce the amount of torque to be generated in the steering motor required for friction control. In general, the amount of torque of a motor is related to the size of the motor, so that if the amount of torque required to be generated reduces, a motor with a reduced size may be used.

Further, in a case where friction control is performed with the system friction tuned to be relatively high, in the loss-of-assist (LOA) condition where vehicle steering assist does not operate, a higher level of steering stability may be given to the driver as compared with when the system friction is tuned to be relatively high.

The motor control device 100 is described again below in light of a method, and what has been described above is omitted as necessary, but is also applicable to the method.

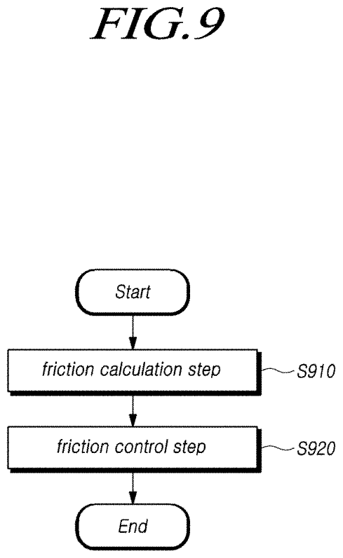

FIG. 9 is a flowchart illustrating a motor control method according to an embodiment.

Referring to FIG. 9, a motor control method according to an embodiment may include a friction calculation step S910 and a friction control step S920.

The friction calculation step S910 may include calculating friction control information for controlling friction of a steering device based on vehicle state information including information regarding a state of a vehicle and preset system friction information.

The friction calculation step S910 may calculate friction torque information based on the vehicle state information and preset table information.

For example, the friction calculation step S910 may calculate friction torque information based on vehicle velocity information and table information and calculate friction torque information based on steering angle information and table information.

The system friction information may be corrected. For example, the system friction information may be corrected based on the information calculated based on the above-described friction measurement result.

The friction control step S920 may include performing either friction decrease control to control to reduce the friction of the steering device or friction increase control to control to increase the friction of the steering device, based on the friction control information.

Specifically, the friction control information may include information for controlling to generate a motor torque of a specific magnitude in a specific direction.

If the magnitude of the motor torque is negative, the steering motor may be controlled to generate a motor torque in the same direction as the direction of the steering torque to allow the magnitude of the friction generated in the steering device to be smaller than the system friction. Conversely, if the magnitude of the motor torque is positive, the steering motor may be controlled to generate a motor torque in the opposite direction to the direction of the steering torque.

The friction control step S920 may include performing friction measurement control based on the friction measurement control information for controlling to measure the friction of the steering device.

The friction measurement control may be set to be performed when a preset friction measurement condition is met. For example, the friction measurement condition may be set to include at least one of a condition where the gear shift state information about the vehicle is determined to be a parking state or a neutral state, a condition where the vehicle velocity information is determined to be less than a preset stop reference velocity, or a condition where the steering torque information is determined to be less than a preset stop reference torque.

The friction measurement control may be performed in such a manner as to perform measurement by applying a friction measurement current for measuring the friction of the steering device to the steering motor. In this case, the friction measurement current may be allowed to be applied to the steering motor when the above-described friction measurement condition is met, so that the accuracy of friction measurement is increased.

When the friction measurement control is performed so that the friction of the steering device is measured, the calculator 110 may compare the friction measurement result with the system friction information to calculate the friction difference value.

As a result of the calculation, if the friction difference value is less than a preset correction reference value, this may mean that there is no significant change between the friction measurement result and the existing system friction information, so that the friction decrease control or friction increase control may be performed without correcting the system friction information.

If the friction difference value is the correction reference value or more, correction may be performed to apply the friction measurement result to the system friction information, and friction decrease control or friction increase control may be performed based on the corrected system friction information.

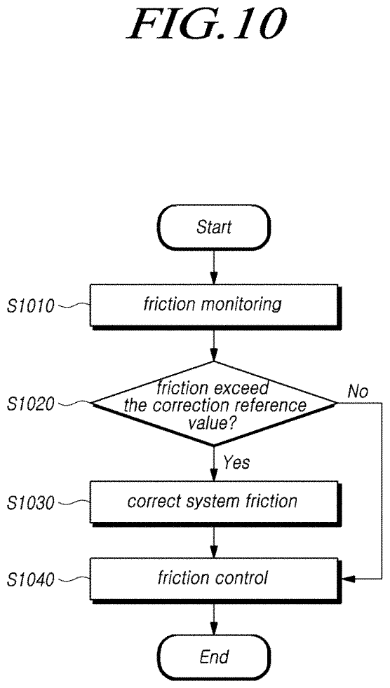

FIG. 10 is a flowchart illustrating an example configuration for friction monitoring and correction according to an embodiment.

Referring to FIG. 10, friction monitoring and correction according to an embodiment may include a friction monitoring step S1010, an over-correction reference value determination step S1020, a system friction correction step S1030, and a friction control step S1040.

The friction monitoring step S1010 may include controlling to monitor the friction of the steering device. The monitoring may be set to be performed when a preset friction monitoring condition is met.

For example, the friction monitoring condition may be set to perform the friction monitoring step S1010 at dawn when the driver is not in the vehicle or when the vehicle is parked for a long time.

Specifically, the friction monitoring condition may be set to include at least one of a condition where the gear shift state information about the vehicle is determined to be a parking state or a neutral state, a condition where the vehicle velocity information is determined to be less than a preset stop reference velocity, or a condition where the steering torque information is determined to be less than a preset stop reference torque.

The friction monitoring may be performed in such a manner as to measure the friction of the steering device by applying a friction measurement current to the steering motor.

The over-correction reference value determination step S1020 may compare the friction monitoring result with system friction information to calculate a friction difference value and determine whether the friction difference value is a preset correction reference value or more.

Accordingly, if the friction difference value is determined to be the correction reference value or more, the system friction correction step S1030 may be performed. Alternatively, when the friction difference value is determined to be less than the correction reference value, the friction control step S1040 may be performed.

The system friction correction step S1030 may correct the system friction information based on the friction monitoring result.

In a case where the friction difference value is the correction reference value or more, if friction control is performed based on the existing system friction information, the accuracy of friction control may be reduced. Thus, the system friction information may be corrected with the information calculated as the friction of the steering device according to the friction monitoring result.

The friction control step S1040 may perform either the friction decrease control or the friction increase control based on the friction control information.

In this case, the friction control information may be calculated based on the existing system friction information or the corrected friction information depending on the friction monitoring result.

In some cases, even when the friction difference value is determined to be less than the correction reference value, friction control may be performed in such a manner as to apply part of the friction monitoring result to calculation of the friction control information without correcting the existing system friction information. Thus, it is possible to enhance the accuracy of friction control.

As described above, the motor control device and method according to the disclosure may control the magnitude of friction of the steering device depending on the condition of the vehicle.

Specifically, it is possible to perform either friction decrease control or friction increase control according to the friction required for the condition of the vehicle, e.g., the driver's getting in or out of the vehicle, need for delivering the road condition while driving the vehicle, or lock stop of the steering wheel, based on the system friction tuned in the steering device mechanism.

In particular, when the physical rotation of the steering wheel is not limited due to, e.g., adoption of a steer-by-wire steering device in the vehicle, the lock stop function is more critical. Thus, the friction control according to the disclosure may be more effective.

The disclosure may provide a motor control device and method capable of reducing the torque required for the motor in controlling the friction of the steering device and optimizing the motor size.

Specifically, it is possible to reduce the control range of friction increase control through friction tuning and friction control. Accordingly, the motor control device 100 may reduce the amount of torque to be generated in the steering motor required for friction control. In general, the amount of torque of a motor is related to the size of the motor, so that if the amount of torque required to be generated reduces, a motor with a reduced size may be used in vehicle steering control.

Further, according to the disclosure, since friction control is performed with the system friction tuned to be relatively high, a higher level of steering stability may be given to the driver in the loss-of-assist (LOA) condition where vehicle steering assist does not operate.

The disclosure may also provide a motor control device and method capable of more sophisticated friction control by monitoring the friction of the steering device.

The above description has been presented to enable any person skilled in the art to make and use the technical idea of the disclosure, and has been provided in the condition of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed is:

1. A motor control device, comprising:
a calculator calculating friction control information for controlling friction of a steering device based on vehicle state information including information regarding a state of a vehicle and preset system friction information; and
a controller performing either friction decrease control to control to reduce the friction of the steering device or friction increase control to control to increase the friction of the steering device, based on the friction control information,
wherein the vehicle state information includes steering torque information about the vehicle.

2. The motor control device of claim 1, wherein the calculator calculates friction torque information regarding friction torque required for the steering device based on the vehicle state information and preset table information and calculates the friction control information based on the friction torque information and the system friction information,
and wherein the controller controls a steering motor to generate the friction torque in the steering device to perform either the friction decrease control or the friction increase control.

3. The motor control device of claim 1, wherein the vehicle state information further includes vehicle velocity information about the vehicle, and
wherein the calculator calculates the friction control information based on a result of comparison between the vehicle velocity information and a preset stop reference velocity.

4. The motor control device of claim 3, wherein the controller controls the steering motor to generate a torque in a same direction as the steering torque information to perform the friction decrease control when the vehicle velocity information is determined to be the stop reference velocity or more, and controls the steering motor to generate a torque in a direction opposite to the steering torque information to perform the friction increase control when the vehicle velocity information is determined to be less than the stop reference velocity.

5. The motor control device of claim 1, wherein the vehicle state information further includes steering angle information about the vehicle, and
wherein the controller controls the steering motor to generate a torque in a direction opposite to the steering torque information to perform the friction increase control when the steering angle information is determined to be a preset limit steering angle or more.

6. The motor control device of claim 1, wherein the friction control information includes friction measurement control information to control to measure the friction of the steering device, and
wherein the controller performs friction measurement control regarding the steering device based on the friction measurement control information when a preset friction measurement condition is met and performs either the friction decrease control or the friction increase control based on at least one of a friction measurement result and the system friction information.

7. The motor control device of claim 6, wherein the vehicle state information further includes at least one of gear shift state information and vehicle velocity information about the vehicle or the steering torque information, and
wherein the friction measurement condition includes at least one of a condition where the gear shift state information is determined to be a parking state or a neutral state, a condition where the vehicle velocity information is determined to be less than a preset stop reference velocity, or a condition where the steering torque information is determined to be less than a preset stop reference torque.

8. The motor control device of claim 6, wherein the calculator calculates a friction difference value by comparing the friction measurement result and the system friction information and, when the friction difference value is a preset correction reference value or more, corrects the system friction information based on the friction measurement result.

9. A motor control method, comprising:
a friction calculation step calculating friction control information for controlling friction of a steering device based on vehicle state information including information regarding a state of a vehicle and preset system friction information; and
a friction control step performing either friction decrease control to control to reduce the friction of the steering device or friction increase control to control to increase the friction of the steering device, based on the friction control information,
wherein the vehicle state information includes steering torque information about the vehicle.

10. The motor control method of claim 9, wherein the friction calculation step calculates friction torque information regarding friction torque required for the steering device based on the vehicle state information and preset table information and calculates the friction control information based on the friction torque information and the system friction information, and
wherein the friction control step controls a steering motor to generate the friction torque in the steering device to perform either the friction decrease control or the friction increase control.

11. The motor control method of claim 9, wherein the vehicle state information further includes vehicle velocity information about the vehicle, and
wherein the friction calculation step calculates the friction control information based on a result of comparison between the vehicle velocity information and a preset stop reference velocity.

12. The motor control method of claim 11, wherein the friction control step controls the steering motor to generate a torque in a same direction as the steering torque information to perform the friction decrease control when the vehicle velocity information is determined to be the stop reference velocity or more, and controls the steering motor to generate a torque in a direction opposite to the steering torque information to perform the friction increase control when the vehicle velocity information is determined to be less than the stop reference velocity.

13. The motor control method of claim 9, wherein the friction control information includes friction measurement control information to control to measure the friction of the steering device, and
wherein the friction control step performs friction measurement control regarding the steering device based on the friction measurement control information when a preset friction measurement condition is met and performs either the friction decrease control or the friction increase control based on at least one of a friction measurement result and the system friction information.
